(19) United States
(12) Patent Application Publication
(10) Pub. No.: US 2018/0047323 A1
(43) Pub. Date: Feb. 15, 2018

(54) DRIVING CIRCUIT AND OPERATING METHOD THEREOF

(71) Applicant: Raydium Semiconductor Corporation, Hsinchu (TW)

(72) Inventors: SHANG-PING TANG, Zhubei City (TW); HUNG LI, Taipei City (TW)

(21) Appl. No.: 15/647,536

(22) Filed: Jul. 12, 2017

(30) Foreign Application Priority Data
Aug. 12, 2016 (TW) 105125811

(51) Int. Cl. G09G 3/20

(52) U.S. Cl. CPC G09G 3/20; G09G 2310/0291; G09G 2330/023; G09G 2310/04

(57) ABSTRACT

A driving circuit includes a data comparator, a data processor and a driver. The data comparator determines whether a second row of image data is the same with a previous first row of image data. If YES, the data comparator outputs a disable signal, then the data processor stops operating according to the disable signal and outputs an indicating signal, and the driver outputs a previous first row of output image data to a panel according to the indicating signal; if NO, the data comparator outputs the second row of image data to replace the previous first row of image data, then the data processor processes the second row of image data to generate a second row of output image data, and the driver outputs the second row of output image data to the panel to replace the previous first row of output image data.

### BACKGROUND OF THE INVENTION

### 1. Field of the Invention

This invention relates to a driving circuit, especially to a display panel driving circuit and an operating method thereof applied to a display apparatus.

### 2. Description of the Prior Art

In a conventional liquid crystal display apparatus, a driving IC is usually used to receive input image data from outside and use its internal digital image processing circuit to perform data processing on the input image data and then the processed input image data is transmitted to the source driver to generate output voltage to the display panel.

Please refer to FIG. 1 and FIG. 2. FIG. 1 illustrates a schematic diagram of the display panel driving circuit including a frame storage in the prior art; FIG. 2 illustrates a schematic diagram of the display panel driving circuit without frame storage in the prior art.

No matter the frame storage is included or not, if the same image data SIN is continuously inputted from outside, the digital processing circuit 14 of the driving circuit 1 and the digital processing circuit 24 of the driving circuit 2 should repeat the same process to generate the same processed image data and then the source driver 15 will generate the same output voltage to the display panel PL. These repeated data processing procedures will cause unnecessary power consumption, and this drawback is needed to be overcome.

### SUMMARY OF THE INVENTION

Therefore, the invention provides a driving circuit and an operating method thereof to solve the above-mentioned problems.

An embodiment of the invention is a driving circuit. In this embodiment, the driving circuit is disposed in a display apparatus and coupled to a display panel. The driving circuit includes a data comparator, a data processor and a driver. The data comparator is used for determining whether a second row of image data is the same with a previous first row of image data, wherein if the second row of image data is the same with the first row of image data, the data comparator outputs a disable signal; if the second row of image data is different from the first row of image data, the data comparator outputs the second row of image data to replace the first row of image data. The data processor is coupled to the data comparator, wherein when the data processor receives the disable signal from the data comparator, the data processor stops operating according to the disable signal and outputs an indicating signal; when the data processor receives the second row of image data from the data comparator, the data processor processes the second row of image data to generate a second row of output image data. The driver is coupled between the data processor and the display panel, wherein when the driver receives the indicating signal from the data processor, the driver outputs a previous first row of output image data to the display panel according to the indicating signal; when the driver receives the second row of output image data from the data processor, the driver outputs the second row of output image data to the display panel to replace the first row of output image data.

In an embodiment, the driving circuit further includes a transmission interface and another data processor. The transmission interface is used for receiving an input image data from outside. The another data processor is coupled among the transmission interface, the data comparator and the data processor and used for performing data processing on the input image data to generate a frame of image data, wherein the frame of image data includes the first row of image data and the second row of image data.

In an embodiment, the driving circuit further includes a row buffer. The row buffer is coupled between the another data processor and the data processor and used for receiving and temporarily storing the first row of image data or the second row of image data.

In an embodiment, if there is no other row of image data previous to the first row of image data in the frame of image data, the row buffer directly transmits the first row of image data to the data processor and the data processor performs data processing on the first row of image data to generate the first row of output image data.

In an embodiment, two input terminals of the data comparator are coupled to an input terminal and an output terminal of the row buffer respectively, the first row of image data is previous to the second row of image data in the frame of image data, the data comparator compares the first row of image data with the second row of image data to determine whether the first row of image data is the same with the second row of image data; if the first row of image data is different from the second row of image data, the row buffer uses the second row of image data to replace the temporarily stored first row of image data.

In an embodiment, the driving circuit further includes a transmission interface, another data processor and a frame storage. The transmission interface is used for receiving an input image data from outside. The another data processor is coupled to the transmission interface and used for performing data processing on the input image data to generate a frame of image data, wherein the frame of image data includes the first row of image data and the second row of image data. The frame storage is coupled among the another data processor, the data comparator and the data processor and used for receiving and temporarily storing the frame of image data.

In an embodiment, the driving circuit further includes a row buffer. The row buffer is coupled between the frame storage and the data processor and used for receiving and temporarily storing the first row of image data or the second row of image data.

In an embodiment, if there is no other row of image data previous to the first row of image data in the frame of image data, the row buffer directly transmits the first row of image data to the data processor and the data processor performs data processing on the first row of image data to generate the first row of output image data.

In an embodiment, two input terminals of the data comparator are coupled to an input terminal and an output terminal of the row buffer respectively, the first row of image data is previous to the second row of image data in the frame of image data, the data comparator compares the first row of image data with the second row of image data to determine whether the first row of image data is the same with the second row of image data; if the first row of image data is different from the second row of image data, the row buffer uses the second row of image data to replace the temporarily stored first row of image data.

Another embodiment of the invention is a driving circuit operating method. In this embodiment, the driving circuit operating method is used for operating a driving circuit disposed in a display apparatus. The driving circuit is coupled to a display panel. The driving circuit includes a data comparator, a data processor and a driver. The data processor is coupled to the data comparator. The driver is coupled between the data processor and the display panel. The driving circuit operating method includes steps of: (a) using the data comparator to determine whether a second row of image data is the same with a previous first row of image data, wherein if the second row of image data is different from the first row of image data, the data comparator outputs the second row of image data to replace the first row of image data; (b) if the second row of image data is the same with the first row of image data, outputting a disable signal to control the data processor to stop operating and output an indicating signal to the driver, and the driver outputs a previous first row of output image data to the display panel according to the indicating signal; and (c) if the second row of image data is different from the first row of image data, outputting the second row of image data to the data processor to replace the previous first row of output image data, the data processor performing data processing on the second row of image data to generate a second row of output image data to the driver, and the driver outputting the second row of output image data to the display panel to replace the first row of output image data.

Compared to the prior art, the display panel driving circuit and operating method thereof of the invention will determine whether the current row of image data is the same with the pervious row of image data according to the input image data. If the current row of image data is the same with the pervious row of image data, the display panel driving circuit and operating method thereof of the invention will stop the data processing of the back-end digital image processing circuit and directly output the row image data stored in the data driving circuit (namely the source driver). Therefore, the unnecessary and power consumptive data processing procedures can be effectively stopped to achieve the effect of reducing digital electrical power consumption.

The advantage and spirit of the invention may be understood by the following detailed descriptions together with the appended drawings.

### BRIEF DESCRIPTION OF THE APPENDED DRAWINGS

FIG. 1 illustrates a schematic diagram of the display panel driving circuit including a frame storage in the prior art.

FIG. 2 illustrates a schematic diagram of the display panel driving circuit without frame storage in the prior art.

FIG. 3A illustrates a schematic diagram of the display panel driving circuit including a frame storage in an embodiment of the invention.

FIG. 3B illustrates a schematic diagram of the frame of image data SF including a plurality of rows of image data wherein the first row of image data and the second row of image data are the same.

FIG. 3C illustrates a schematic diagram of the frame of image data SF including a plurality of rows of image data wherein the first row of image data and the second row of image data are different.

FIG. 4 illustrates a schematic diagram of the display panel driving circuit without frame storage in another embodiment of the invention.

FIG. 5 illustrates a schematic diagram of the driving circuit further including a row buffer in the invention.

FIG. 6 illustrates a flowchart of the driving circuit operating method in another embodiment of the invention.

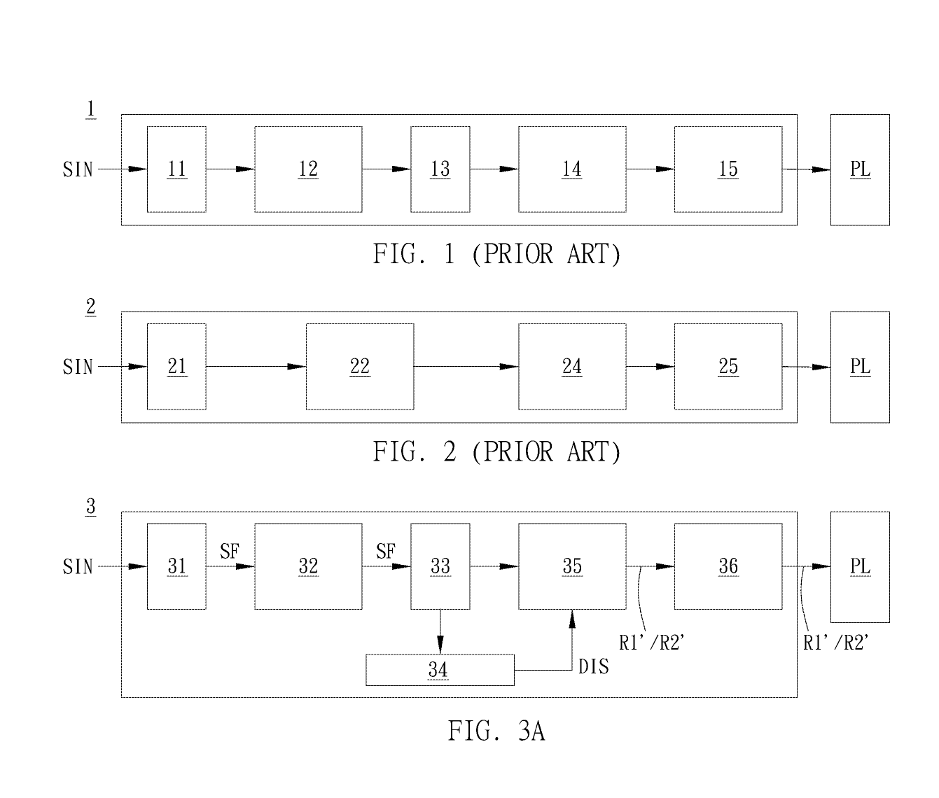

### DETAILED DESCRIPTION OF THE INVENTION

The invention provides a driving circuit disposed in a display apparatus and coupled to a display panel. When the driving circuit determines that the current row of image data is the same with the pervious row of image data according to the input image data, the driving circuit of the invention will stop the data processing of the back-end digital image processing circuit and directly output the row image data stored in the source driver. Therefore, the unnecessary and power consumptive data processing procedures can be effectively stopped to achieve the effect of reducing digital electrical power consumption.

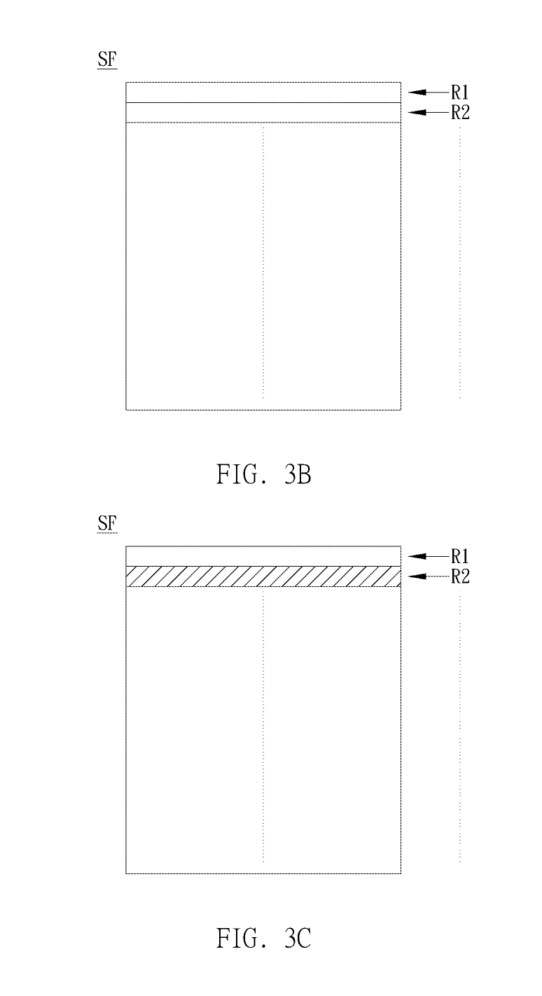

A preferred embodiment of the invention is a display panel driving circuit. It should be noticed that the display panel driving circuit in this embodiment includes a frame storage. Please refer to FIG. 3A. FIG. 3A illustrates a schematic diagram of the display panel driving circuit including a frame storage in this embodiment.

As shown in FIG. 3A, the display panel driving circuit 3 coupled to the display panel PL includes a transmission interface 31, a first data processor 32, a frame storage 33, a data comparator 34, a second data processor 35 and a source driver 36. Wherein, the transmission interface 31 is coupled to the first data processor 32; the first data processor 32 is coupled to the frame storage 33; the frame storage 33 is coupled to the data comparator 34 and the second data processor 35; the data comparator 34 is coupled to the second data processor 35; the second data processor 35 is coupled to the source driver 36; the source driver 36 is coupled to the display panel PL.

Next, the above-mentioned units of the display panel driving circuit 3 will be introduced in detail as follows.

The transmission interface 31 is used for receiving an input image data SIN from outside, and then the first data processor 32 will perform data processing on the input image data SIN to generate a frame of image data SF. The frame storage 33 is used for receiving the frame of image data SF from the transmission interface 31 and temporarily storing the frame of image data SF.

It should be noticed that, as shown in FIG. 3B and FIG. 3C, the frame of image data SF at least includes multiple rows of image data including a first row of image data R1 and a second row of image data R2, wherein the first row of image data R1 is previous to the second row of image data R2. That is to say, the frame storage 33 will receive and temporarily store two adjacent rows of image data (namely the first row of image data R1 and the second row of image data R2) in the frame of image data SF in order. The difference between FIG. 3B and FIG. 3C is that the first row of image data R1 and the second row of image data R2 in FIG. 3B are the same, but the first row of image data R1 and the second row of image data R2 in FIG. 3C are different.

When the frame storage 33 receives and temporarily stores the first row of image data R1 in the frame of image data SF, the data comparator 34 will access the first row of image data R1 from the frame storage 33. At this time, since there is no other image data previous to the first row of image data R1, the data comparator 34 fails to compare the first row of image data R1 with other image data. Instead, the second data processor 35 will access the first row of image data R1 from the frame storage 33 and perform data processing on the first row of image data R1 to generate a first row of output image data R1′ to the source driver 36. Then, the source driver 36 will output the first row of output image data R1′ to the display panel PL, and the display panel PL will display the first row of output image data R1′.

When the frame storage 33 receives and temporarily stores the second row of image data R2 in the frame of image data SF, the data comparator 34 will access the second row of image data R2 from the frame storage 33. At this time, the data comparator 34 can compare the current accessed second row of image data R2 with the previous accessed first row of image data R1 to determine whether the second row of image data R2 is the same with the first row of image data R1.

If the data comparator 34 determines that the second row of image data R2 is the same with the first row of image data R1, as shown in FIG. 3B, the data comparator 34 will output a disable signal DIS to the second data processor 35, and the second data processor 35 will stop operating according to the disable signal DIS and output an indicating signal K to the source driver 36.

It should be noticed that since the second data processor 35 stops operating according to the disable signal DIS at this time, the second data processor 35 will neither access the second row of image data R2 from the frame storage 33 nor perform any data processing on the second row of image data R2. By doing so, the invention can effectively stop the unnecessary and power consumptive data processing procedure performed in prior art to reduce the digital electrical power consumption.

When the source driver 36 receives the indicating signal K from the second data processor 35, the source driver 36 will still output the first row of output image data R1′ to the display panel PL instead of outputting other new output image data.

If the data comparator 34 determines that the second row of image data R2 is different from the first row of image data R1, as shown in FIG. 3C, the data comparator 34 will output the second row of image data R2 to the second data processor 35 to replace the previous first row of image data R1.

When the second data processor 35 receives the second row of image data R2, the second data processor 35 will perform data processing on the second row of image data R2 to generate a second row of output image data R2′ to the source driver 36.

When the source driver 36 receives the second row of output image data R2′ from the second data processor 35, the source driver 36 will stop outputting the first row of output image data R1′ to the display panel PL. Instead, the source driver 36 will output the second row of output image data R2′ to the display panel PL.

As to other rows of image data in the frame of image data SF, such as a third row of image data, a fourth row of image data, . . . and so on, since they are similar to the above-mentioned first row of image data R1 and second row of image data R2, it is not repeated here.

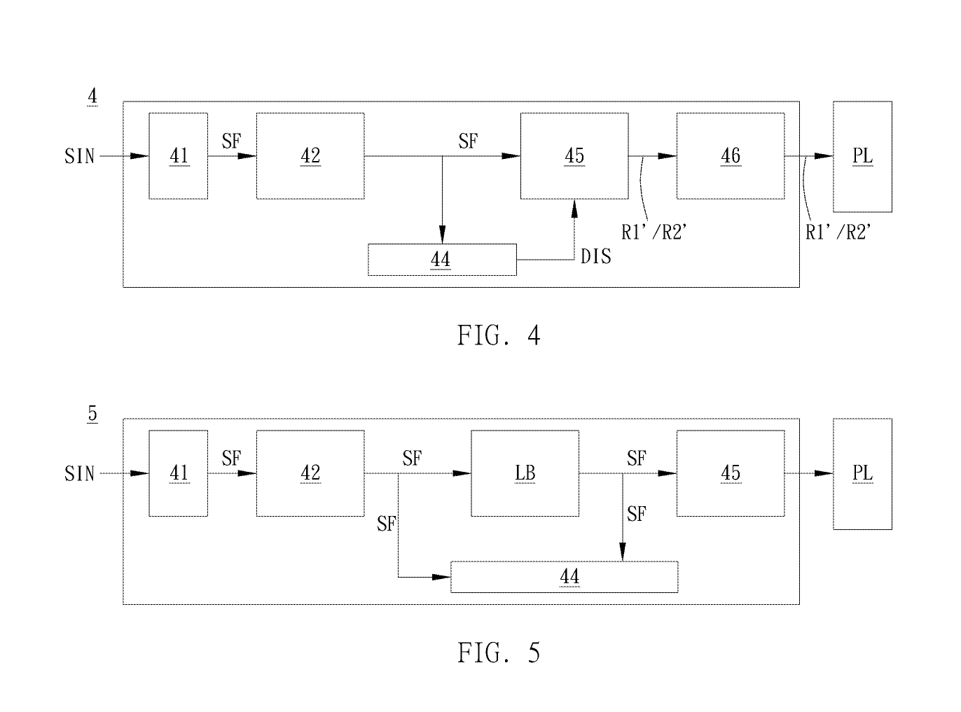

Please refer to FIG. 4. In another embodiment, the display panel driving circuit 4 can also include no frame storage. As shown in FIG. 4, the display panel driving circuit 4 coupled to the display panel PL includes a transmission interface 41, a first data processor 42, a data comparator 44, a second data processor 45 and a source driver 46. Wherein, the transmission interface 41 is coupled to the first data processor 42; the first data processor 42 is coupled to the data comparator 44 and the second data processor 45; the data comparator 44 is coupled to the second data processor 45; the second data processor 45 is coupled to the source driver 46; the source driver 46 is coupled to the display panel PL.

Next, the above-mentioned units of the display panel driving circuit 4 will be introduced in detail as follows.

The transmission interface 41 is used for receiving an input image data SIN from outside, and then the first data processor 42 will perform data processing on the input image data SIN to generate a frame of image data SF. It should be noticed that, the frame of image data SF at least includes a first row of image data R1 and a second row of image data R2, wherein the first row of image data R1 is previous to the second row of image data R2.

When the data comparator 44 receives the first row of image data R1 from the first data processor 42, since there is no other image data previous to the first row of image data R1, the data comparator 44 fails to compare the first row of image data R1 with other image data. Instead, the second data processor 45 will receive the first row of image data R1 and perform data processing on the first row of image data R1 to generate a first row of output image data R1′ to the source driver 46. Then, the source driver 46 will output the first row of output image data R1′ to the display panel PL, and the display panel PL will display the first row of output image data R1′.

When the data comparator 44 receives the second row of image data R2 from the first data processor 42, the data comparator 44 will compare the current accessed second row of image data R2 with the previous accessed first row of image data R1 to determine whether the second row of image data R2 is the same with the first row of image data R1. If the data comparator 44 determines that the second row of image data R2 is the same with the first row of image data R1, as shown in FIG. 3B, the data comparator 44 will output a disable signal DIS to the second data processor 45, and the second data processor 45 will stop operating according to the disable signal DIS and output an indicating signal K to the source driver 46. When the source driver 46 receives the indicating signal K from the second data processor 45, the source driver 46 will still output the first row of output image data R1′ to the display panel PL according to the indicating signal K. By doing so, the invention can effectively stop the unnecessary and power consumptive data processing procedure performed in prior art to reduce the digital electrical power consumption.

If the data comparator 44 determines that the second row of image data R2 is different from the first row of image data R1, as shown in FIG. 3C, the data comparator 44 will output the second row of image data R2 to the second data processor 45 to replace the previous first row of image data R1. When the second data processor 45 receives the second row of image data R2 from the data comparator 44, the second data processor 45 will perform data processing on the second row of image data R2 to generate a second row of output image data R2′ to the source driver 46. When the source driver 46 receives the second row of output image data R2′ from the second data processor 45, the source driver 46 will stop outputting the first row of output image data R1′ to the display panel PL. Instead, the source driver 46 will output the second row of output image data R2′ to the display panel PL.

In practical applications, as shown in FIG. 5, the display panel driving circuit 5 can further include a row buffer LB. The row buffer LB is coupled among the first data processor 42, the data comparator 44 and the second data processor 45 and used for receiving and temporarily storing the first row of image data R1 or the second row of image data R2 in the frame of image data SF in order.

In the frame of image data SF, since there is no other row of image data previous to the first row of image data R1, the row buffer LB will directly transmit the first row of image data R1 to the second data processor 45 and the second data processor 45 will perform data processing on the first row of image data R1 to generate the first row of output image data R1′.

As to the data comparator 44, two input terminals of the data comparator 44 are coupled to an input terminal and an output terminal of the row buffer LB respectively. Since the first row of image data R1 is previous to the second row of image data R2 in the frame of image data SF, the data comparator 44 will compare the first row of image data R1 with the second row of image data R2 to determine whether the first row of image data R1 is the same with the second row of image data R2.

If the first row of image data R1 is different from the second row of image data R2, as shown in FIG. 3C, the row buffer LB will use the second row of image data R2 to replace the temporarily stored first row of image data R1.

If the first row of image data R1 is the same with the second row of image data R2, as shown in FIG. 3B, the row buffer LB will maintain the temporarily stored first row of image data R1 unchanged.

Another embodiment of the invention is a driving circuit operating method. In this embodiment, the driving circuit operating method is used for operating a driving circuit disposed in a display apparatus. The driving circuit is coupled to a display panel. The driving circuit includes a data comparator, a data processor and a driver. The data processor is coupled to the data comparator. The driver is coupled between the data processor and the display panel.

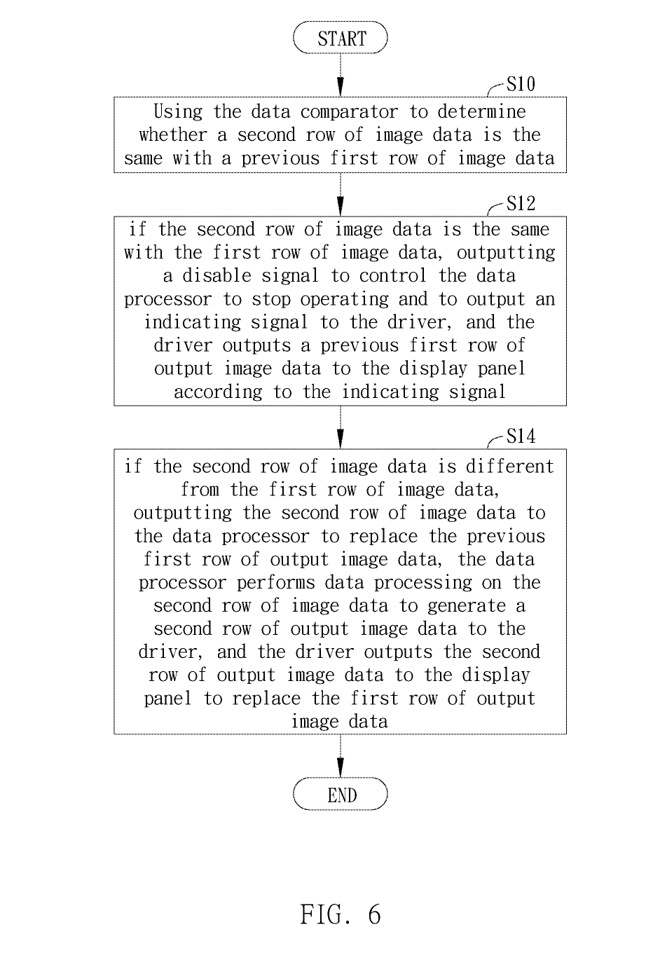

Please refer to FIG. 6. FIG. 6 illustrates a flowchart of the driving circuit operating method in this embodiment. As shown in FIG. 6, the driving circuit operating method includes the following steps (S10)˜(S14) of:

(S10) using the data comparator to determine whether a second row of image data is the same with a previous first row of image data, wherein if the second row of image data is different from the first row of image data, the data comparator outputs the second row of image data to replace the first row of image data;

(S12) if the second row of image data is the same with the first row of image data, the method outputs a disable signal to control the data processor to stop operating and to output an indicating signal to the driver, and the driver outputs a previous first row of output image data to the display panel according to the indicating signal; and

(S14) if the second row of image data is different from the first row of image data, the method outputs the second row of image data to the data processor to replace the previous first row of output image data, the data processor performs data processing on the second row of image data to generate a second row of output image data to the driver, and the driver outputs the second row of output image data to the display panel to replace the first row of output image data.

Compared to the prior art, the display panel driving circuit and operating method thereof of the invention will determine whether the current row of image data is the same with the pervious row of image data according to the input image data. If the current row of image data is the same with the pervious row of image data, the display panel driving circuit and operating method thereof of the invention will stop the data processing of the back-end digital image processing circuit and directly output the row image data stored in the data driving circuit (namely the source driver). Therefore, the unnecessary and power consumptive data processing procedures can be effectively stopped to achieve the effect of reducing digital electrical power consumption.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A driving circuit, disposed in a display apparatus and coupled to a display panel, the driving circuit comprising:
a data comparator, for determining whether a second row of image data is the same with a previous first row of image data, wherein if the second row of image data is the same with the first row of image data, the data comparator outputs a disable signal; if the second row of image data is different from the first row of image data, the data comparator outputs the second row of image data to replace the first row of image data;
a data processor, coupled to the data comparator, wherein when the data processor receives the disable signal from the data comparator, the data processor stops operating according to the disable signal and outputs an indicating signal; when the data processor receives the second row of image data from the data comparator, the data processor processes the second row of image data to generate a second row of output image data; and
a driver, coupled between the data processor and the display panel, wherein when the driver receives the indicating signal from the data processor, the driver outputs a previous first row of output image data to the display panel according to the indicating signal; when the driver receives the second row of output image data from the data processor, the driver outputs the second row of output image data to the display panel to replace the first row of output image data.

2. The driving circuit of claim 1, further comprising:
a transmission interface, for receiving an input image data from outside; and
another data processor, coupled among the transmission interface, the data comparator and the data processor, for performing data processing on the input image data to generate a frame of image data, wherein the frame of image data comprises the first row of image data and the second row of image data.

3. The driving circuit of claim 2, further comprising:
a row buffer, coupled between the another data processor and the data processor, for receiving and temporarily storing the first row of image data or the second row of image data.

4. The driving circuit of claim 3, wherein if there is no other row of image data previous to the first row of image data in the frame of image data, the row buffer directly transmits the first row of image data to the data processor and the data processor performs data processing on the first row of image data to generate the first row of output image data.

5. The driving circuit of claim 4, wherein two input terminals of the data comparator are coupled to an input terminal and an output terminal of the row buffer respectively, the first row of image data is previous to the second row of image data in the frame of image data, the data comparator compares the first row of image data with the second row of image data to determine whether the first row of image data is the same with the second row of image data; if the first row of image data is different from the second row of image data, the row buffer uses the second row of image data to replace the temporarily stored first row of image data.

6. The driving circuit of claim 1, further comprising:
a transmission interface, for receiving an input image data from outside;
another data processor, coupled to the transmission interface, for performing data processing on the input image data to generate a frame of image data, wherein the frame of image data comprises the first row of image data and the second row of image data; and
a frame storage, coupled among the another data processor, the data comparator and the data processor, for receiving and temporarily storing the frame of image data.

7. The driving circuit of claim 6, further comprising:
a row buffer, coupled between the frame storage and the data processor, for receiving and temporarily storing the first row of image data or the second row of image data.

8. The driving circuit of claim 7, wherein if there is no other row of image data previous to the first row of image data in the frame of image data, the row buffer directly transmits the first row of image data to the data processor and the data processor performs data processing on the first row of image data to generate the first row of output image data.

9. The driving circuit of claim 8, wherein two input terminals of the data comparator are coupled to an input terminal and an output terminal of the row buffer respectively, the first row of image data is previous to the second row of image data in the frame of image data, the data comparator compares the first row of image data with the second row of image data to determine whether the first row of image data is the same with the second row of image data; if the first row of image data is different from the second row of image data, the row buffer uses the second row of image data to replace the temporarily stored first row of image data.

10. A driving circuit operating method for operating a driving circuit disposed in a display apparatus, the driving circuit being coupled to a display panel, the driving circuit comprising a data comparator, a data processor and a driver, the data processor being coupled to the data comparator, the driver being coupled between the data processor and the display panel, the driving circuit operating method comprising steps of:
(a) using the data comparator to determine whether a second row of image data is the same with a previous first row of image data, wherein if the second row of image data is different from the first row of image data, the data comparator outputs the second row of image data to replace the first row of image data;
(b) if the second row of image data is the same with the first row of image data, outputting a disable signal to control the data processor to stop operating and output an indicating signal to the driver, and the driver outputs a previous first row of output image data to the display panel according to the indicating signal; and
(c) if the second row of image data is different from the first row of image data, outputting the second row of image data to the data processor to replace the previous first row of output image data, the data processor performing data processing on the second row of image data to generate a second row of output image data to the driver, and the driver outputting the second row of output image data to the display panel to replace the first row of output image data.

11. The driving circuit operating method of claim 10, wherein the driving circuit further comprises a transmission interface and another data processor, the another data processor is coupled among the transmission interface, the data comparator and the data processor, the driving circuit operating method further comprises:
using the transmission interface to receive an input image data from outside; and
using the another data processor to perform data processing on the input image data to generate a frame of image data, wherein the frame of image data comprises the first row of image data and the second row of image data.

12. The driving circuit operating method of claim 11, wherein the driving circuit further comprises a row buffer coupled between the another data processor and the data processor, the driving circuit operating method further comprises:
using the row buffer to receive and temporarily store the first row of image data or the second row of image data from the another data processor.

13. The driving circuit operating method of claim 12, wherein if there is no other row of image data previous to the first row of image data in the frame of image data, the driving circuit operating method further comprises:
using the row buffer to directly transmit the first row of image data to the data processor; and
using the data processor to perform data processing on the first row of image data to generate the first row of output image data.

14. The driving circuit operating method of claim 13, wherein two input terminals of the data comparator are coupled to an input terminal and an output terminal of the row buffer respectively, the first row of image data is previous to the second row of image data in the frame of image data, the driving circuit operating method further comprises:
using the data comparator to compare the first row of image data with the second row of image data to determine whether the first row of image data is the same with the second row of image data; and
if the first row of image data is different from the second row of image data, the row buffer using the second row of image data to replace the temporarily stored first row of image data.

15. The driving circuit operating method of claim 10, wherein the driving circuit further comprises a transmission interface, another data processor and a frame storage, the another data processor is coupled to the transmission interface, the frame storage is coupled among the another data processor, the data comparator and the data processor, the driving circuit operating method further comprises:
using the transmission interface to receive an input image data from outside;
using the another data processor to perform data processing on the input image data to generate a frame of image data, wherein the frame of image data comprises the first row of image data and the second row of image data; and
using the frame storage to receive and temporarily store the frame of image data.

16. The driving circuit operating method of claim 15, wherein the driving circuit further comprises a row buffer coupled between the frame storage and the data processor, the driving circuit operating method further comprises:
using the row buffer to receive and temporarily store the first row of image data or the second row of image data.

17. The driving circuit operating method of claim 16, wherein if there is no other row of image data previous to the first row of image data in the frame of image data, the driving circuit operating method further comprises:
using the row buffer to directly transmit the first row of image data to the data processor; and
using the data processor to perform data processing on the first row of image data to generate the first row of output image data.

18. The driving circuit operating method of claim 17, wherein two input terminals of the data comparator are coupled to an input terminal and an output terminal of the row buffer respectively, the first row of image data is previous to the second row of image data in the frame of image data, the driving circuit operating method further comprises:
using the data comparator to compare the first row of image data with the second row of image data to determine whether the first row of image data is the same with the second row of image data; and
if the first row of image data is different from the second row of image data, the row buffer using the second row of image data to replace the temporarily stored first row of image data.
